(19) United States
(12) Patent Application Publication
(10) Pub. No.: US 2007/0125696 A1
(43) Pub. Date: Jun. 7, 2007

(54) Device and method for increasing the concentration of fuel in a liquid flow supplied to the anode of a fuel cell

(75) Inventors: Anders Oedegaard, Freiburg (DE); Christopher Hebling, Freiburg (DE)

Correspondence Address: MARSHALL & MELHORN, FOUR SEAGATE, EIGHT FLOOR, TOLEDO, OH, 43604, US

(73) Assignee: FRAUNHOFER-GESELLSCHAFT ZUR FOERDERUNG DER ANGEWANDTEN FORSCHUNG E.V., MUNICH (DE)

(21) Appl. No.: 10/576,375

(22) PCT Filed: Oct. 21, 2004
(86) PCT No.: PCT/EP04/11916

§ 371 Date: Apr. 19, 2006

(30) Foreign Application Priority Data
Oct. 21, 2003 (DE) 103 48 879.0

(51) Int. Cl. B01D 63/00; H01M 8/04

(52) U.S. Cl. 210/321.6; 429/34

(57) ABSTRACT

The invention relates to the field of fuel cell technology, more specifically to a device and a method for supplying fuel to the anode of a direct alcohol fuel cell. Said device comprises a fuel accumulator in which the fuel is stored, and a flow-through device provided with a wall at least partially consisting of a membrane that is permeable to the fuel. Said flow-through device is used to guide a mixture of a carrier constituent and the fuel through the fuel accumulator, and the concentration of fuel in the mixture is increased by the diffusion of fuel through the permeable membrane.

The present invention relates in the field of fuel cell technology to a device and a method for the supply of a diluted fuel to the anode of a fuel cell. Fuel cells are devices in which an electrochemical reaction is used in order to obtain electrical energy. In the last few decades, fuel cells have attracted a great deal of attention. This is due to their potential high energy density and in the overall reduction in waste gases or waste products in comparison to current energy generation systems. Because of their modular nature, the entire range of energy generation can be covered by them, from energy generation for small portable applications to large energy generation plants. Dependent upon the application and the materials which are used as components of the fuel cell, a multiplicity of materials can be used as fuel for the cell. Because of their high energy density, organic materials, such as methanol or formaldehyde, are attractive candidates as fuel.

A fuel cell converts chemical energy into electrical energy with the help of two electrochemical reactions which, separately from each other, take place in reaction chambers which are separated from each other by an electrolytic ion conductor. In a hydrogen-operated polymer electrolyte membrane fuel cell (PEMFC), hydrogen is oxidised on the anode into protons. The protons migrate through the electrolytic membrane to the cathode, whilst the electrons stay retained because of the electrical insulation properties of the membrane or they are forced into an external electrical circuit. On the cathode, oxygen is reduced to water with the help of electrons and protons, which is the only emission product of the hydrogen-operated PEMFC.

It is desired that fuel cells replace the rechargeable batteries used today in small electrical appliances. In the field of portable electronic applications, such as for example with portable computers, an energy supply device with high energy density, such as a fuel cell represents, is extremely desirable since this field usually suffers from an inadequate running time per battery charge. Possible embodiments of fuel cells for portable computer systems are the polymer electrolyte membrane fuel cell (PEMFC) and the direct methanol fuel cell (DMFC). The PEMFC is operated with hydrogen and has high energy densities but suffers from various disadvantages, such as unsatisfactory fuel storage and safety aspects which must be taken into account, such as heat and water management which are not satisfactorily resolved, and finding materials for use in the hydrogen environment which are adapted thereto. On the other hand, the DMFC has a lower energy density because of problems with the reaction kinetics and the interference of fuel, i.e. the methanol passing through the electrolytic membrane. The main advantage of the DMFC is the simple storage of fuel with high energy density (methanol) and the simplicity of the entire system structure. In the DMFC, the electrochemical reaction on the anode is the conversion of methanol and water into carbon dioxide (CO₂), hydrogen ions (H⁺) and electrons (e⁻). The hydrogen ions flow through a polymer or plastic material membrane as electrolyte to the cathode, whilst the free electrons flow through a consumer unit which is normally connected between the anode and the cathode. On the cathode, oxygen reacts with hydrogen ions and free electrons to form water. Hence the discharge of a DMFC comprises only carbon dioxide and water. Such a direct methanol fuel cell is described for example in the printed patent specification U.S. Pat. No. 5,599,638.

In the last few years, various prototypes of fuel cell systems for portable applications have been presented. However further development work is necessary in order to make them comparable with batteries or other devices for generating comparatively small quantities of energy. In order to make the high potential energy density usable, a better storage and supply system is necessary (for supplying the fuel to the anode). At the moment, the focus of development resides hereby more on the system side, i.e. for example in selecting suitable building parts and components and in developing control routines which enable stable operation.

Devices for changing the concentration of a fuel intended for a fuel cell in a mixture of carrier component and fuel are already state of the art. The printed patent specification WO 02/14212 A1 describes a method for mixing a fuel with water, an associated device and use of both. In order to ensure a power-based control of a fuel cell, use of fuel mixtures with a defined flow rate is necessary. In order to produce such a mixture, according to this patent specification, water is pumped through a hollow body which comprises, at least in various sections, a wall which is made of a porous material, fuel being pumped in a region on the other side of the porous wall at a defined flow rate. As a consequence of the pressure difference, the fuel penetrates via the entire surface of the porous wall through the latter, which leads to production of a homogeneous mixture. In the associated device (10, 20), at least different sections of the hollow body (1, 21) have porous walls (2, 22). A device of this type is used preferably in direct methanol fuel cells DMFC in which the operating temperature and the operating pressure can be established in advance.

U.S. Pat. No. 3,833,016 describes a device for precise controllable dilution of gas samples. Concentrated gas samples, for example waste gas samples, are diluted with high precision in that a controlled diffusion takes place through a permeable membrane, for example made of Teflon. The membrane divides a cylindrically configured housing into two parts in that it is introduced into the housing perpendicular to the cylinder axis. In each of the two parts, a bell-shaped core is introduced which, since its end wall has a spacing from the membrane, forms a gas throughflow passage on opposite sides of the membrane which extends transversely to the cylinder axis and hence enables the gas to flow past the membrane. Also the side walls of the bell-shaped core have a spacing from the cylindrical housing and hence form a longitudinal flow passage for the gas which has an annular cross-section. Gas samples are conducted in via each longitudinal flow passage and conducted away via each transverse passage with the help of a pipe which extends through the end wall of the respective core. Electrical heating elements are fitted on the side wall of the housing; these are controlled with the help of temperature sensors which are fitted in the gas passage extending transversely to the cylinder axis adjacent to the permeable membrane. The entire housing is surrounded by insulating material so that precise control of the temperature in the housing is possible. In contrast to the present invention, the membrane is hence used as a wall in a flow-past device in which gas flows are conducted past on both sides of the membrane. The membrane serves for diluting a gas flow, not for increasing the concentration of a liquid fuel in a mixture of fuel and carrier component. Pressure is applied on both sides of the membrane.

The printed patent specification U.S. Pat. No. 0,127,141 A1 shows a fuel container with a plurality of walls and also a supply system. The printed document discloses a fuel container and a supply device which can be used with a direct methanol fuel cell. The container and the supply device uses fuel which, in a preferred embodiment, is guided to the fuel cell in the form of either pure methanol or an aqueous methanol/water mixture. Before the fuel is guided out of the fuel cell, a substance containing fuel is mixed with additives. The substance containing fuel is accommodated in an inner tank which has an outer container. A mixing chamber which is defined by the space between the outer container and a flexible balloon is filled with the additives such that, when the entire supply device is ruptured, the substance containing the fuel is mixed with the additives. In one embodiment of the invention, the inner tank is a flexible balloon. A rupturing device on a needle is disclosed which withdraws the fuel in pure form and tears open the flexible balloon so that all the still remaining fuel is mixed with the additives, when it is necessary to use the container or to fill it up again.

The German patent DE 35 08 153 discloses a fuel cell system in which a methanol/water mixture is supplied with the help of a tank. In order to set a predetermined methanol concentration, a specific quantity of methanol is added in addition with the help of a control element.

In a direct methanol fuel cell DMFC, the hydrogen of the methanol and of the water is used according to the following reaction equation:
CH₃OH+H₂O->CO₂+6H⁺+6e⁻

Hence it is necessary to supply a mixture of methanol and water to the anode, ideally in a molar ratio of 1:1. One of the greatest problems in the DMFC is the interference of the methanol through the membrane or the electrolyte. The proton transport (hydrogen ions) in the polymer or plastic material membrane or the electrolyte is followed by water. In a PEMFC, each proton entrains for instance two to three water molecules from the anode to the cathode. As a result of the physical similarity between methanol and water (e.g. size of molecule, dipolar moment), both liquids in a DMFC pass though the electrolyte from the anode to the cathode. This leads to a mixed potential on the cathode and to an overall lower cell voltage. In order to minimise these losses, the volumetric mixing ratio between methanol and water which is commonly used nowadays is between 1:20 and 1:10 (vol/vol).

If one regards the entire reaction equation of a direct methanol fuel cell, then one sees that water is produced during the operation:
CH₃OH+ 3/2O₂->2H₂O+CO₂

This means that no water need be refilled. It is hence adequate if methanol is supplied to the system in the desired quantity. Nowadays, this is either implemented by (1) storing an already diluted fuel or (2) by using two tanks, one for water and one for concentrated methanol. Storage of concentrated methanol as in (2) is to be preferred because of the much higher energy density. (2) causes however also a more complicated supply and mixing system. Each tank requires a pump for supply control and the tanks must be combined with a fuel concentration sensor and a mixing tank in order to ensure the flow of diluted fuel to the fuel cell. Hence, by storing concentrated methanol, a high yield of energy density can be noted but this is at the expense of a more complex system. In order in fact to optimise operation, it is necessary to equalise the methanol concentration to the varying load by simply adding the quantity of methanol consumed on the anode. The US printed patent specification U.S. Pat. No. 0,086,193 A1 (device and method for sensorless optimisation of the methanol concentration in a direct methanol fuel cell) shows this. The printed patent specification shows a device and methods for controlling the methanol concentration in a direct methanol fuel cell without a methanol sensor being required. This takes place in that one or more operating parameters of the fuel cell are used, such as for example the potential difference at the consumer unit, the potential of the open circuit, the potential on the anode close to the end of the fuel supply device or the short circuit current of the fuel cell, in order to control the methanol concentration actively.

As already described, it is desired to supply diluted fuel to direct alcohol fuel cells or direct methanol fuel cells, i.e. a mixture of water and fuel/methanol. This increases the energy which can be obtained with the cell since the voltage losses because of the interference of methanol are reduced. The dilution of the methanol does however involve other disadvantages:
The construction of a fuel cell system becomes more complicated and more expensive because of structures and processes which are required in order to store and handle the water.
The energy per unit of volume of the fuel cell system, this is a critical factor in relation to the potential, commercial applications of the fuel cell, is reduced.

It is the object of the present invention to provide a simply constructed and simple to operate device which operates in the throughflow method for changing or increasing the concentration of a fuel for a fuel cell in a mixture of carrier component and fuel. The mixture of carrier component and fuel is supplied to the anode of the fuel cell.

This object is achieved by the device according to patent claim 1 and a method according to patent claim 26. Advantageous developments of the device according to the invention and also of the described methods and uses are described in the respective dependent claims.

A fuel concentration increasing device according to the invention for increasing the concentration of a fuel in a mixture of a carrier component and the fuel, the mixture being used for example in a fuel cell, has the following components. In a fuel storage device, for example a tank, at least one throughflow device is disposed, with the help of which the mixture of carrier component and fuel is conducted through the fuel storage device. It is now crucial that the throughflow device is configured as a membrane which is permeable or semi-permeable for the fuel with the corresponding transport properties or that the throughflow device has such a membrane. With the help of this membrane, the advantageously concentrated fuel which is situated in the fuel storage device is added to the mixture of carrier component and fuel, in that the mixture of carrier component and fuel is conducted through the throughflow device and in that the diffusion properties of the membrane with respect to the fuel are used. The fuel stored in the fuel storage device diffuses hence through the throughflow device, configured as a membrane, or through the membrane part of the throughflow device, the throughflow device can for example advantageously concern a channel in the throughflow device with a circular cross-section, as a result of which the concentration of the fuel in the anode supply flow or in the mixture of carrier component and fuel is increased on its path through the throughflow device. The basis of the invention is hence to use the advantageous transport properties of substances in membranes which are permeable or semi-permeable for the fuel, in that these are used in the storage and supply system of direct methanol fuel cells. In that the diluted anode supply flow of fuel is conducted through such a membrane throughflow device introduced in a fuel tank, fuel (alcohol) can hence be added passively to the anode supply flow.

In a first advantageous embodiment, the device according to the invention is configured such that the throughflow device enables a multiple throughflow of the fuel/carrier component mixture so that the concentration of fuel in the mixture is increased many times. This can be produced advantageously with the help of a throughflow loop which can be configured for example in the form of a spiral. In a further advantageous embodiment, a plurality of throughflow devices or a plurality of channels is conducted through the fuel storage device or through the fuel tank. The individual throughflow devices can hereby have any shapes and sizes and be orientated in any way relative to the fuel tank. It goes without saying that this applies also to the presence of only one throughflow device. In a further embodiment of the device according to the invention, water produced on the cathode of the fuel cell is re-used, in that it is added to the anode supply flow. In a further advantageous embodiment, the fuel tank of the devices according to the invention is provided with components, stabilising or support devices, for example made of foamed material or other materials in order to achieve an operation which is independent of the spatial orientation or respectively a spatially independent mode of operation. In a further advantageous embodiment, the foamed material or another support material is disposed around a membrane throughflow device which is permeable or semi-permeable for the fuel such that the device can be operated independently of its physical orientation. In a further advantageous embodiment, at least one filter is inserted in the fuel tank and/or in the inflow and/or outflow region of the throughflow device. In a further advantageous embodiment, the device is provided with heat insulation and/or heating for the fuel tank. In a further advantageous embodiment the device is connected thermally or physically to the fuel cell. It goes without saying that the device according to the invention can be operated or used also with carrier components other than water, with more or less concentrated fuel in the fuel tank, with anode supply flows of any type and flow velocity, with membranes which are permeable or semi-permeable for the fuel and made of any materials and/or, in addition to the already mentioned methanol, with the most varied of fuels such as for example ethanol.

Relative to the state of the art, the above-described fuel concentration increasing device has a series of advantages:
It is possible with the help of the device to store methanol in concentrated form without configuring the system for the fuel supply in a complicated manner by means of the use of a plurality of pumps. This reduces the volume required by the system and hence increases the energy density of the system. The fuel supply system of liquid-operated direct alcohol fuel cells is hence simpler since only a single pump is required for the supply of the anode. The fuel cell system is hence more compact, more simple in its construction and also more economical.
With the device presented according to the invention, it is possible to add methanol passively to the anode supply flow of the fuel/water mixture in a simple manner.
Less energy-consuming components are required in the system.

Devices according to the invention can be configured or used for increasing the concentration of a fuel for a fuel cell, as described in one of the subsequent examples. The Figures associated with the examples and described subsequently have corresponding reference numbers for the same or corresponding components or building parts of the device.

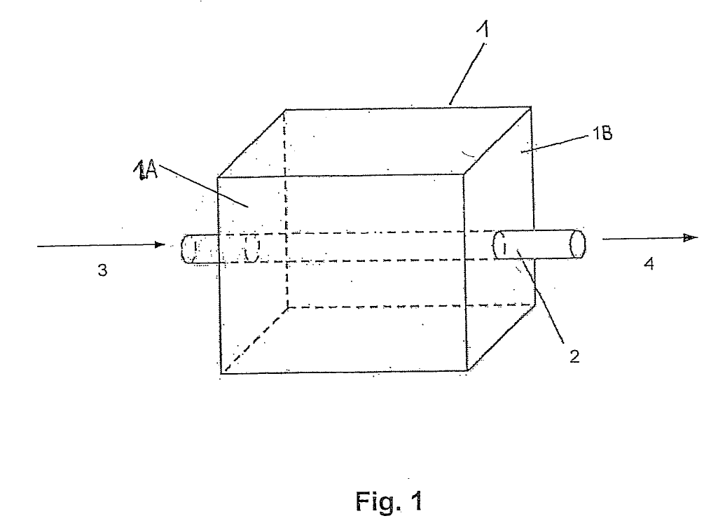

FIG. 1 shows schematically a tank containing a fuel through which a channel comprising a membrane which is permeable for the fuel leads.

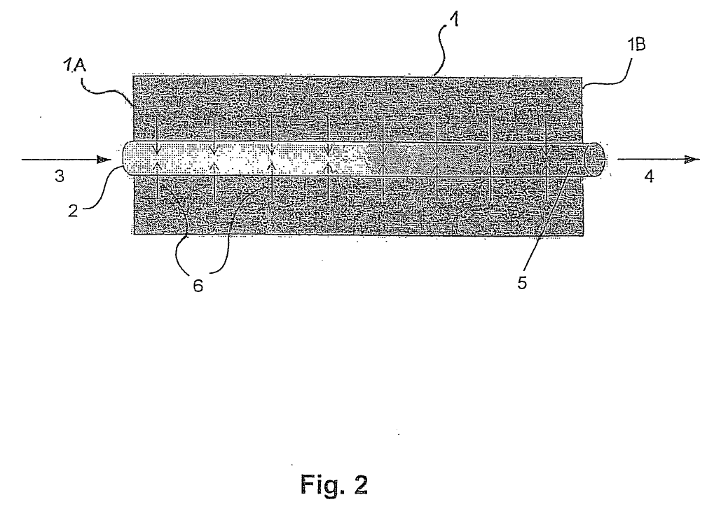

FIG. 2 illustrates schematically the increase in concentration of the fuel in the device shown in FIG. 1.

In a three-dimensional view, FIG. 1 shows a cuboid tank 1 which is filled with concentrated methanol. A throughflow channel 2 with a circular cross-section is guided through the left wall 1A of the tank 1 into the tank 1. The walls of the throughflow channel comprise a membrane from DuPont™, Nafion®, a perfluorosulphonic acid/polytetrafluoroethane copolymer in acidic (H⁺) form. The cylinder axis of the cylindrical throughflow channel 2 hereby stands perpendicularly on the wall 1A and perpendicularly on the right wall 1B of the tank 1, the throughflow channel 2 being guided again out of the tank 1 through the latter. From the left, a mixture of methanol and water is introduced 3 into the throughflow channel 2. Subsequently, after flowing through the portion of the throughflow channel 2 situated in the tank 1, the mixture is conducted 4 out of the throughflow channel 2 again on the right. The walls of the throughflow channel 2 comprise a membrane which is permeable for methanol. The cube hence represents a methanol storage tank 1 which is filled with concentrated methanol. The anode supply flow, a mixture of methanol and water, is conducted in the channel 2. The walls comprising a membrane which is permeable for methanol make it possible for methanol to diffuse from the methanol storage tank 1 into the channel 2 and hence into the mixture of water and methanol. The methanol concentration in the anode supply flow is consequently increased until the supply flow flows through the methanol tank 1. With this construction of the system, a second pump is not necessary, concentrated methanol can be stored whilst, at the same time, the anode supply flow has a lower methanol concentration.

FIG. 2 shows the increase in the methanol concentration during the throughflow of a mixture of methanol and water through a channel 2 with a circular cross-section. The Figure shows a tank 1 in a two-dimensional representation, in three-dimensional indication the channel 2 which leads through the left wall 1A and the right wall 1B of the tank 1 and also the introduction 3 of a mixture of methanol and water with a lower methanol initial concentration from the left into the channel 2 and the discharge 4 of the mixture of methanol and water with an increased methanol concentration from the right out of the channel 2. The increase in methanol concentration 5 is shown schematically by grey shading of the interior of the channel increasing from the left to the right. The diffusion of methanol from the tank into the channel is characterised by arrows 6. FIG. 2 hence shows the increase in methanol concentration in the mixture whilst the latter flows in the region of the channel 2 which is situated in the interior of the tank 1. The diffusion of methanol through the membrane walls of the channel 2 which are permeable for methanol is effected on the basis of the difference in concentration of the methanol in the storage tank 1 and in the anode supply flow in the channel 2. Concentrated methanol is 24.6 molar (mol methanol/litre), the optimal anode supply flow has a 1 to 2 molar concentration, i.e. approx. 1 part methanol to 20 parts water (vol/vol). The transport through the membrane which is permeable for methanol also depends upon the temperature, the pressure and the membrane thickness. Hence the methanol concentration of the flow 4 of mixture discharging from the channel is determined by the mentioned properties plus the flow velocity and the length of the channel in the filled tank or in the region of the membrane which is subjected to the methanol situated in the tank.

1-36. (canceled)

37. A fuel concentration increasing device for increasing the concentration of a fuel in a liquid mixture of a fuel and a carrier component comprising:
at least one fuel storage device in which the fuel is storable; and
at least one throughflow device which is disposed at least partially in the fuel storage device for conducting the mixture of fuel and carrier component through the fuel storage device, wherein the throughflow device contains at least one membrane which is permeable or semi-permeable for the fuel but not for the carrier component or comprising such a membrane so that, because of the transport properties of the membrane, fuel can be added passively to the liquid mixture of fuel and carrier component.

38. The device according to claim 37, wherein the device is disposed on a fuel cell and/or has a fuel exchange connection to a fuel cell for exchanging the mixture of fuel and carrier component.

39. The device according to claim 37, wherein the fuel cell is a direct methanol fuel cell.

40. The device according to claim 37, wherein the fuel cell comprises a cathode, and water produced on the cathode of the fuel cell can be coupled into the mixture of fuel and carrier component.

41. The device according to claim 37, wherein a heating device is disposed on the device in order to heat fuel stored in the fuel storage device and/or the mixture of fuel and carrier component and/or in that the device is connected thermally or physically to a fuel cell.

42. The device according to claim 37, wherein heat insulation is integrated in the fuel storage device or disposed thereon.

43. The device according to claim 42, wherein the heat insulation contains or comprises insulating material and/or in that the heat insulation has walls together with a vacuum situated therebetween.

44. The device according to claim 37, wherein the mixture of carrier component and fuel can be conducted through the throughflow device more than once for a multiple increase in the concentration of the fuel in the mixture.

45. The device according to claim 37, wherein the fuel storage device contains or comprises a container and/or a tank.

46. The device according to claim 37, wherein the fuel storage device contains fuel in pure or in concentrated form.

47. The device according to claim 37, wherein the fuel storage device contains fuel in a carrier component, the fuel being present in 50 to 100 percent concentration.

48. The device according to claim 37, wherein at least one support device and/or stabilizing device is disposed in the fuel storage device.

49. The device according to claim 48, wherein at least one of the disposed support or stabilizing devices contains or comprises foamed material.

50. The device according to claim 37, wherein the membrane comprises a perfluorosulphonic acid/polytetrafluoroethylene copolymer in acidic (H⁺) form.

51. The device according to claim 37, wherein the throughflow rate for the mixture of carrier component and fuel through the throughflow device has an order of magnitude in the range of 0.1 ml/min to 1000 ml/min.

52. The device according to claim 37, wherein a support device is disposed on or around the throughflow device in order to achieve an arbitrary spatial orientation of the throughflow device.

53. The device according to claim 52, wherein the support device comprises foamed material.

54. The device according to claim 37, wherein the throughflow device comprises at least one channel.

55. The device according to claim 54, wherein the channel has a circular cross-section.

56. The device according to claim 37, wherein at least one filter is disposed in the throughflow device.

57. The device according to claim 37, wherein the carrier component and/or the fuel comprises a liquid.

58. The device according to claim 37, wherein the carrier component comprises water, water vapor and/or a mixture thereof with further materials.

59. The device according to claim 58, wherein the carrier component comprises an acid.

60. The device according to claim 37, wherein the fuel comprises an alcohol.

61. The device according to claim 60, wherein the fuel comprises methanol and/or ethanol.

62. A fuel concentration increasing method for increasing the concentration of a fuel in a liquid mixture of a fuel and a carrier component, wherein at least one throughflow device is disposed at least partially in a volume filled with fuel, comprising:
conducting the mixture of fuel and carrier component through the at least one throughflow device which comprises a membrane which is permeable or semi-permeable for the fuel but not for the carrier component so that, because of the transport properties of the membrane, fuel is added passively from the volume of the mixture of the fuel and the carrier component.

63. The method according to claim 62, wherein a fuel concentration device is used, the fuel concentration device comprising:
at least one fuel storage device in which the fuel is storable; and
at least one throughflow device which is disposed at least partially in the fuel storage device for conducting the mixture of fuel and carrier component through the fuel storage device, wherein the throughflow device contains at least one membrane which is permeable or semi-permeable for the fuel but not for the carrier component or comprising such a membrane so that, because of the transport properties of the membrane, fuel can be added passively to the liquid mixture of fuel and carrier component.

64. The method according to claim 62, wherein the mixture of fuel and carrier component is conducted through the throughflow device more than once for multiple increase in the concentration of the fuel in the mixture.

65. The method according to claim 62, wherein the mixture of fuel and carrier component is conducted to an anode of a fuel cell after the increase in the concentration.

66. The method according to claim 62, wherein water produced on a cathode of a fuel cell is re-used in that it is introduced into the mixture of fuel and carrier component.

67. The method according to claim 62, wherein the fuel and/or the mixture of fuel and carrier component and/or the carrier component are heated.

68. The method according to claim 62, wherein the mixture of carrier component and fuel is filtered before and/or after being conducted through the throughflow device.

69. A method of utilizing the device according to claim 62, comprising modifying the fuel supply flow to the anode of a fuel cell.

70. The method according to claim 69, wherein the fuel cell is a direct methanol fuel cell.
